(19) United States
(12) Patent Application Publication
(10) Pub. No.: US 2014/0133619 A1
(43) Pub. Date: May 15, 2014

(54) EXTENDED OPERATING CYCLE FOR PRESSURIZED WATER REACTOR

(71) Applicant: Babcock & Wilcox mPower, Inc., (US)

(72) Inventor: Vince J. Bilovsky, Lynchburg, VA (US)

(21) Appl. No.: 13/863,901

(22) Filed: Apr. 16, 2013

Related U.S. Application Data
(60) Provisional application No. 61/625,152, filed on Apr. 17, 2012.

(51) Int. Cl. G21C 7/00

(52) U.S. Cl. CPC G21C 7/00
USPC 376/236

(57) ABSTRACT

A pressurized water reactor (PWR) includes a pressure vessel containing a nuclear reactor core immersed in primary coolant water, control rod assemblies (CRA's), and control rod drive mechanisms (CRDM's) operating the CRA's. The reactor core has axially varying ²³⁵U enrichment and/or axially varying burnable poison concentration. A CRDM controller controls the CRA's over a burn-up cycle that does not include fuel assembly shuffling and is divided into a plurality of burn-up intervals. The CRDM controller is configured to, for each burn up interval: position the CRA's in accordance with a CRA pattern defining a set of fixed positions for the CRA's except for a sub-set of CRA's designated by the CRA pattern as floating CRA's, and control power level of the PWR by adjusting the floating CRA's without not adjusting the CRA's not designated as floating CRA's. The primary coolant water optionally does not contain soluble neutron poison.

This application claims the benefit of U.S. Provisional Application No. 61/625,152 filed Apr. 17, 2012. U.S. Provisional Application No. 61/625,152 filed Apr. 17, 2012 is hereby incorporated by reference in its entirety.

### BACKGROUND

The following relates to the nuclear reactor arts, nuclear reactor operating arts, nuclear power generation arts, and related arts.

In nuclear power plants, the fissile material (typically ²³⁵U-based) is a consumable with a high cost component. It is therefore desired to maximize the fuel utilization (sometimes called “burn-up”) of the nuclear fuel over the fuel cycle which extends from the beginning of cycle (BOC) to the end of cycle (EOC).

In a typical arrangement, a single fuel assembly comprises an array or grid of fuel rods containing the fissile material. The fuel assembly further includes interspersed guide tubes within which control rods comprising neutron absorbing material can be inserted to control reactivity. One (or optionally more) of these guide tubes may be designated as a conduit for in-core instrumentation sensors or the like. An array or grid of fuel assemblies forms the nuclear reactor core. The constituent fuel assemblies making up the core are generally not all identical, but rather are tailored to optimize various performance characteristics.

At BOC the core has its highest unregulated output, because the fissile ²³⁵U concentration is highest, and this output decreases over time. Additionally, local unregulated output can vary across the core due to its finite size. The spatial variation across the core can be countered to some degree by the aforementioned tailoring of the fuel assemblies making up the core.

It is desired for the nuclear reactor to have a relatively steady power output from BOC to EOC. A known way to approximate steady power output over the cycle is chemical shimming using a soluble neutron poison added to the primary coolant water. Soluble boron is a commonly used chemical shim. The chemical shim in the primary coolant is adjusted over the cycle to maintain constant power output. However, soluble boron is caustic and complicates reactor maintenance and safety.

Another known approach is fuel assembly shuffling. In this approach, the fuel assemblies making up the core are periodically rearranged so that fuel assemblies in regions of lower local output are moved to core regions of higher local output, and vice versa. This can achieve more uniform burn of the fuel over the cycle and ensures more complete usage of the fissile material. However, fuel assembly shuffling is highly labor intensive, and the reactor must be shut down each time a fuel assembly shuffle operation is performed.

### SUMMARY

In one embodiment, a fuel cycle management method is performed in conjunction with a pressurized water reactor (PWR) including a nuclear reactor core comprising an array of fuel assemblies each fuel assembly having an associated control rod assembly (CRA), the method comprising: dividing the fuel cycle into burn up intervals; and for each burn up interval, controlling power by adjusting the CRA's of a selected sub-set of fuel assemblies while keeping the CRA's of other fuel assemblies fixed. In some embodiments no soluble poison is used for the fuel cycle management. In some embodiments no fuel assembly shuffling is used for the fuel cycle management. In some embodiments a plurality of CRA patterns are defined each CRA pattern defining a set of fixed positions for the CRA's except for a sub-set of one or more CRA's designated as floating CRA's, each burn-up cycle employs a selected one CRA pattern, and in each burn-up cycle the controlling comprises adjusting only the designated floating CRA's to control power level of the nuclear reactor.

In accordance with another aspect, a method comprises operating a pressurized water reactor (PWR) comprising a nuclear reactor core disposed in a pressure vessel over a burn-up cycle that is divided into a plurality of burn-up intervals, the operating including: for each burn up cycle, positioning a set of control rod assemblies (CRA's) used for controlling reactivity of the nuclear reactor core in accordance with a CRA pattern designated for the burn up cycle; and controlling power level of the PWR by adjusting a sub-set of the CRA's designated as floating CRA's while not adjusting the CRA's that are not designated as floating CRA's. In some embodiments the operating does not include shimming the PWR using a soluble neutron poison. In some embodiments the operating does not include performing fuel assembly shuffling. In some embodiments the CRA patterns in conjunction with axial variation in the nuclear reactor core of at least one of ²³⁵U enrichment and burnable poison concentration provide constant burn rate over the burn-up cycle.

In accordance with another aspect, a pressurized water reactor (PWR) includes a pressure vessel, a nuclear reactor core disposed in the pressure vessel and immersed in primary coolant water, control rod assemblies (CRA's) insertable into the nuclear reactor core to control reactivity, and control rod drive mechanisms (CRDM's) operating the CRA's. The nuclear reactor core has at least one of an axially varying ²³⁵U enrichment and an axially varying burnable poison concentration. A CRDM controller comprising an electronic data processing device communicates with the CRDM's to control the CRA's over a burn up cycle that is divided into a plurality of burn-up intervals. The CRDM controller is configured to, for each burn up interval: position the CRA's in accordance with a CRA pattern designated for the burn-up interval, the CRA pattern defining a set of fixed positions for the CRA's except for a sub-set of CRA's designated by the CRA pattern as floating CRA's, and control power level of the PWR by adjusting the floating CRA's without not adjusting the CRA's that are not designated by the CRA pattern as floating CRA's. In some embodiments the primary coolant water does not contain a soluble neutron poison. In some embodiments the CRDM controller stores or has access to storage that stores a CRA pattern schedule defining the burn-up intervals of the burn-up cycle and the CRA patterns designated for the burn-up intervals.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a perspective partial sectional view of an illustrative nuclear reactor of the pressurized water reactor (PWR) variety with internal steam generators (integral PWR).

FIG. 2 diagrammatically shows a perspective view of one of the fuel assemblies of the nuclear reactor core of the nuclear reactor of FIG. 1.

FIG. 3 is shows the fuel assembly layout for an illustrative example.

FIG. 4 diagrammatically shows the fuel assembly types installed in the nuclear reactor core of the illustrative example.

FIG. 5 diagrammatically shows the core loading assembly map of the illustrative example.

FIGS. 6A-6M show the rod pattern configurations from beginning of cycle (BOC) through end of cycle (EOC) for the fuel cycle of the illustrative example.

FIG. 7 plots calculated nodal peaking versus cycle exposure for the illustrative example.

FIG. 8 plots calculated cold shutdown margin versus cycle exposure for the illustrative example.

FIGS. 9 and 10 diagrammatically show general guidelines for selecting the lateral enrichment and poison distributions to obtain a baseline reactivity.

### DETAILED DESCRIPTION OF THE PREFERRED EMBODIMENTS

Disclosed herein are improved fuel cycle management techniques for a pressurized water reactor (PWR) that enable an extended operating cycle without using a soluble poison such as soluble boron for reactivity control, and optionally without fuel assembly shuffling.

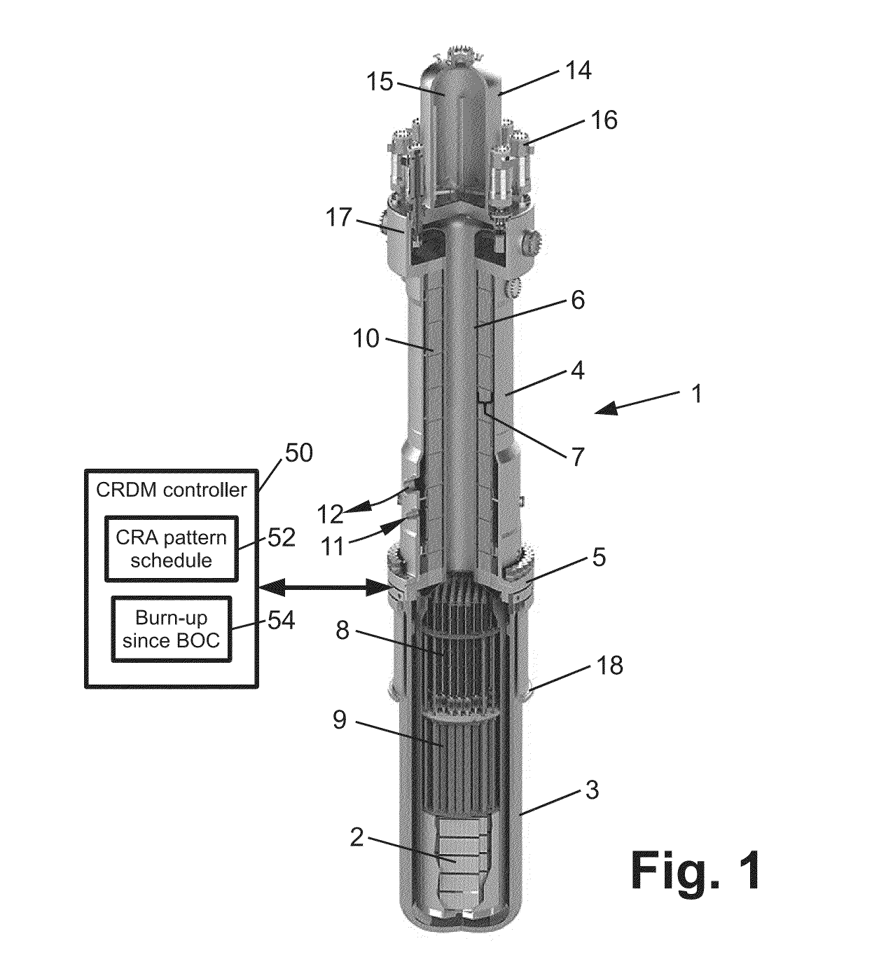

With reference to FIG. 1, an illustrative small modular reactor (SMR) 1 is shown with which the disclosed reactivity control technique is suitably employed. The illustrative SMR 1 is of the pressurized water reactor (PWR). The illustrative PWR 1 includes a nuclear reactor core 2 disposed in a pressure vessel which in the illustrative embodiment comprises a lower vessel portion 3 and an upper vessel portion 4 connected by a mid-flange 5. The reactor core 2 is disposed in the lower vessel portion 3, and comprises a fissile material (e.g., ²³⁵U) immersed in primary coolant water. A cylindrical central riser 6 is disposed coaxially inside the cylindrical pressure vessel and a downcomer annulus 7 is defined between the central riser 6 and the pressure vessel. The illustrative PWR 1 includes internal control rod drive mechanisms (internal CRDMs) 8 that control insertion of control rods to control reactivity; however, the reactor can alternatively employ external CRDMs. In either case, guide frame supports 9 guide the translating control rod assembly (e.g., each including a set of control rods comprising neutron absorbing material yoked together by a spider and connected via a connecting rod with the CRDM). The illustrative PWR 1 employs internal steam generators 10 located inside the pressure vessel, but embodiments with the steam generators located outside the pressure vessel (i.e., a PWR with external steam generators) are also contemplated. The illustrative steam generators 10 are of the once-through straight-tube type with internal economizer, and are fed by a feedwater inlet 11 and deliver steam to a steam outlet 12. The illustrative PWR 1 includes an integral pressurizer 14 at the top of the upper vessel section 4 which defines an integral pressurizer volume 15; however an external pressurizer connected with the pressure vessel via suitable piping is also contemplated. The primary coolant in the illustrative PWR 1 is circulated by reactor coolant pumps (RCPs) comprising in the illustrative example external RCP motors 16 driving an impeller located in a RCP casing 17 disposed inside the pressure vessel. The illustrative PWR 1 also includes an optional support skirt 18. It is to be appreciated that the PWR 1 is merely an illustrative example—the disclosed operating procedures are suitably employed in substantially any type of PWR.

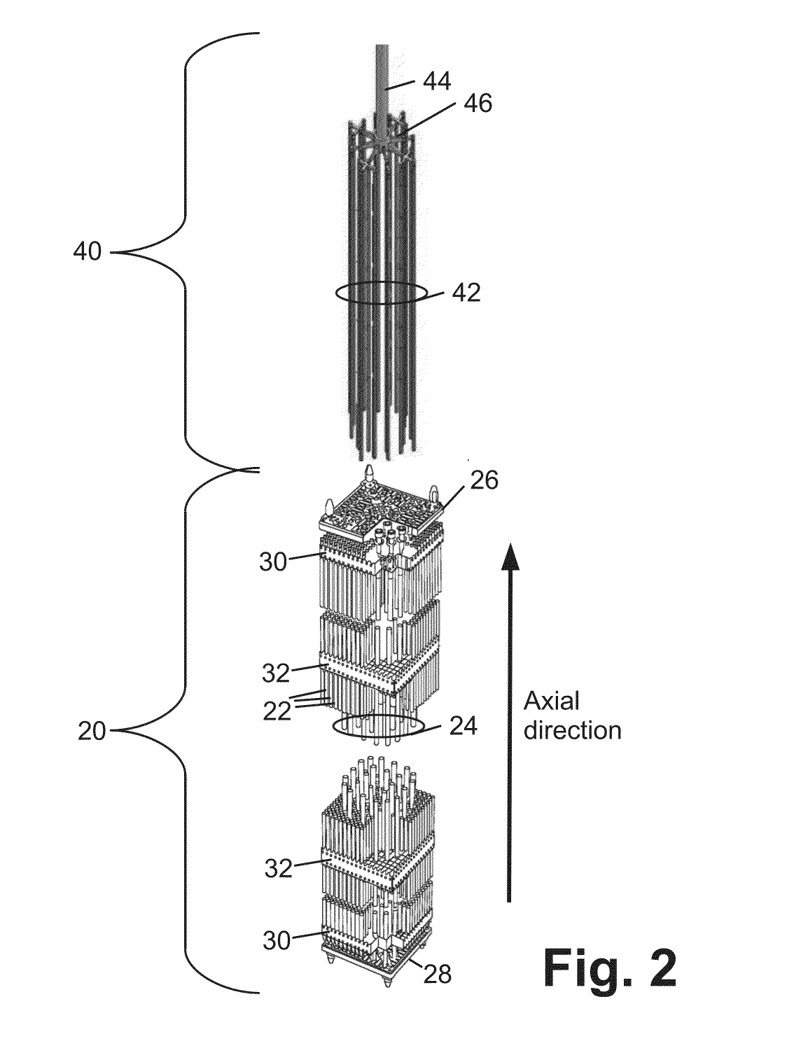

With reference to FIG. 2, a representative fuel assembly 20 is diagrammatically shown with partial breakaway and the front top corner of the perspective view cut away to reveal internal components. The fuel assembly 20 is suitably employed as an element of the nuclear reactor core 2 disposed in the pressure vessel of FIG. 1. The fuel assembly 20 includes an array of vertically oriented fuel rods 22 each comprising a fissile material such as ²³⁵U. Interspersed amongst the fuel rods 20 are guide tubes 24 that provide conduits for control rods, instrumentation, or so forth. The top and bottom of the fuel assembly 20 are terminated by upper and lower end fittings or nozzles 26, 28. The fuel assembly 20 is held together by a plurality of spacer grids including end grids 30 disposed near the top and bottom of the fuel assembly 14 and one or (typically) more mid-grids 32 disposed at spaced apart positions between the top and bottom of the fuel assembly 20.

With continuing reference to FIG. 2, reactivity control is achieved by controlled insertion or withdrawal of a control rod assembly (CRA) 40 that is guided by the guide frame supports 9 shown in FIG. 1. The CRA 40 is a translating assembly including a set of control rods 42 connected with a connecting rod 44 by a yoke or spider 46. The connecting rod 44 operatively connects with one of the CRDMs 8 of FIG. 1 so that the CRDM can raise or lower the CRA 34. FIG. 2 shows the CRA 40 fully withdrawn from the fuel assembly 20. This position, also referred to herein by the acronym “ARO” standing for “all rods out”, provides maximum reactivity in the fuel assembly 20. To reduce the reactivity, the CRDM lowers the CRA 40 downward to a point where the lower ends of the control rods 42 insert into aligned guide tubes 24 of the fuel assembly 20. The control rods 42 (or at least some of the control rods) comprise a neutron poison, and hence the inserted control rods 42 absorb a fraction of the neutrons and reduce reactivity in the fuel assembly 20. The magnitude of the reactivity reduction increases the further the control rods 42 are inserted into the fuel assembly 20 (or more precisely into the guide tubes 24).

To ensure reactor safety, it is preferable to have the “default” condition be for the CRA 40 to be fully inserted, so as to shut down the nuclear chain reaction. Toward this end, the CRDMs 8 are typically configured so that cessation of power to the CRDM 8 causes the controlled CRA 40 to be released so that it falls into the fuel assembly 20, an operation known in the art as “SCRAM”. In view of this, in this description the position of the CRA 40 (or more precisely the control rods 42) in the core is referenced to the fully inserted position (also sometimes referred to as the “parked” position), and the position is quantified by the withdrawal distance of the CRA 40 from the fully inserted (i.e., parked) position. The fully inserted or parked CRA position is designated as position 0 (e.g., 0 mm if the withdrawal distance is measured in millimeters). In the illustrative embodiment, each fuel assembly 20 of the nuclear reactor core 2 has a corresponding CRA 40, as shown in FIG. 2.

With returning reference to FIG. 1, reactivity control from beginning of life (BOL) through end-of-life (EOL) is achieved by controlled withdrawal of the CRA's 40 using the CRDMs 8 operating under control of a CRDM controller 50 which is suitably embodied by a computer, microcontroller, or other electronic data processing device. The CRDM controller 50 causes the CRDMs 8 to insert or withdraw control rod assemblies, typically by sending suitable control signals to a stepper motor or other motor of the CRDM 8 which raises or lowers the CRA 40 via the connecting rod 44 using a suitable linkage such as a lead screw (e.g., ball screw), rack-and-pinion assembly, or so forth. In the illustrative PWR 1 which employs internal CRDMs 8, the cabling (not shown) for the CRDM control signals and for power to the CRDMs enters the pressure vessel via vessel penetrations at or near the mid-flange 5; however, the CRDM vessel penetrations can be elsewhere. In the case of external CRDMs the motors are external and the signal and power cabling runs to the external CRDM motor. The CRDMs 8 also typically include or receive output from position sensors (not shown) that indicate the position (e.g., withdrawal distance) of the CRA 40. Also contemplated is a non-transitory storage medium storing instructions executable by an electronic data processing device (e.g., computer) to perform the functionality of the CRDM controller 50. Such a non-transitory storage medium may, for example, comprise a magnetic storage medium, optical storage medium, electronic storage medium (e.g., random access memory, read-only memory, flash memory, or so forth), various combinations thereof, or so forth.

With continuing returned reference to FIG. 1, the cycle management techniques disclosed herein provide reactivity control over the life of the fuel by adjusting the CRA pattern, which is the positions (e.g., withdrawal distances) of the CRA's 40 controlling the fuel assemblies 20 of the reactor core 2, as a function of the burn-up since beginning of cycle (BOC). Toward this end, the CRDM controller 50 implements a CRA pattern schedule 52 that specifies the CRA pattern as a function of burn-up (for example, using a look-up table to indicate when CRA pattern adjustments should be made). The burn-up is monitored and the current burn-up 54 since BOC is an input to (or is computed by) the CRDM controller 50. The burn-up or fuel utilization 54 is a measure energy extraction from the reactor core 2 since BOC. In the illustrative examples burn-up is specified in units of gigawatt-days/metric ton (GWD/MT), but other measurement units known in the industry can be employed. The burn-up 54 can be directly measured based on the integrated thermal power output and known core mass, or can be estimated based on time-integration of operating parameters.

The reactivity control techniques are described with reference to the following illustrative example.

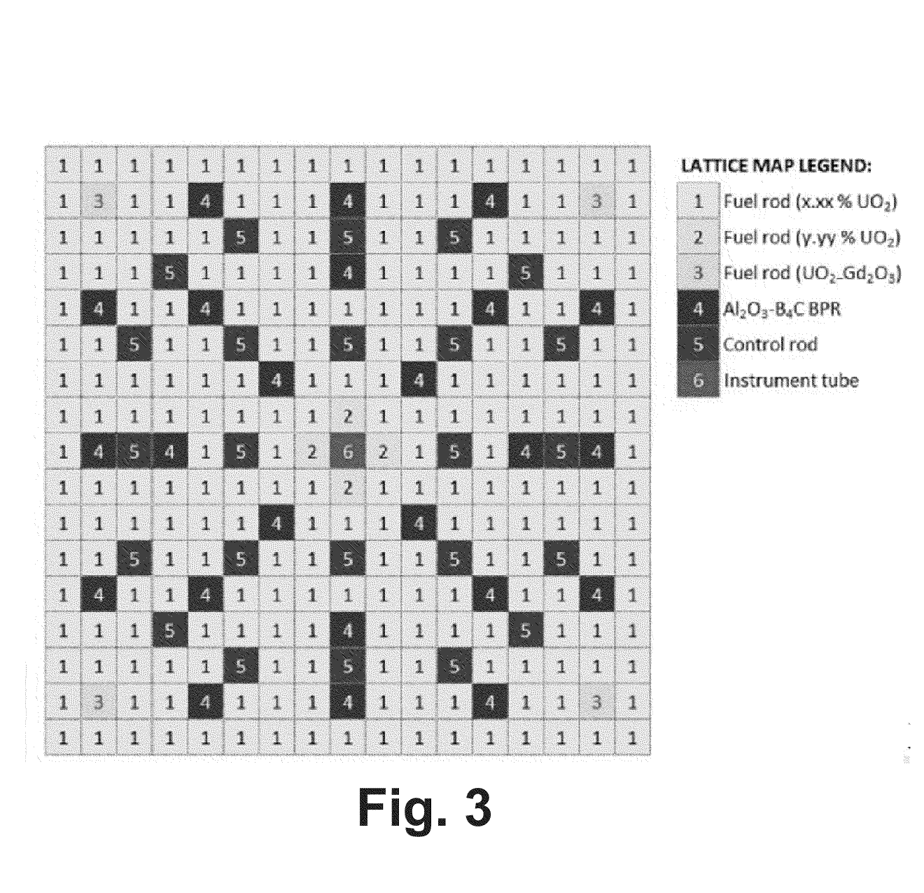

FIG. 3 shows an illustrative fuel assembly layout used in the illustrative example presented herein. The illustrative fuel assembly is a 17×17 square grid, with each “cell” of the grid being occupied by one of: (1) a fuel rod comprising UO₂, (2) a spike fuel rod comprising UO₂Gd₂O₃ for reactivity control, (3) an axially varying burnable poison rod (BPR) comprising Al₂O₃-B₄C, (4) a guide tube for a control rod, or (5) a guide tube for in-core instrumentation (i.e. an instrument tube). The illustrative fuel assembly of FIG. 3 has a single instrument tube at the center of the 17×17 lattice, twenty-four burnable poison rods, four spike fuel rods, and twenty-four control rod guide tubes. The fuel assembly of FIG. 3 includes UO₂ fuel rods of two different ²³⁵U enrichment (ENRU) levels: most fuel rods have enrichment denoted x.xx % (by weight), but the four fuel rods closest to the center of the lattice have a lower enrichment denoted y.yy % (by weight), where y.yy % can be as low as 0%. The spike fuel rods also have y.yy % enrichment.

The lateral distribution of fuel rods, spike fuel rods, BPR, guide tubes, and the central instrumentation tube provides a baseline lateral reactivity distribution which can be adjusted as a function of burn-up by adjusting the CRA pattern. However, there is also variation in the axial direction (indicated in FIG. 2), due to the insertion of the control rods 42 from above (or, equivalently, the withdrawal of control rods 42 starting at the bottom). Reactivity also varies both laterally and axially due to the finite size of the reactor core 2, since at neutrons are only generated within the core 2. A baseline axial reactivity distribution is provided by varying the composition of fuel assembly in the axial direction. Such variation can, in principle, have granularity down to the axial size of the fuel pellets loaded into the fuel rods. However, in the illustrative embodiment the axial compositional variation is implemented on a larger axial “zone” basis.

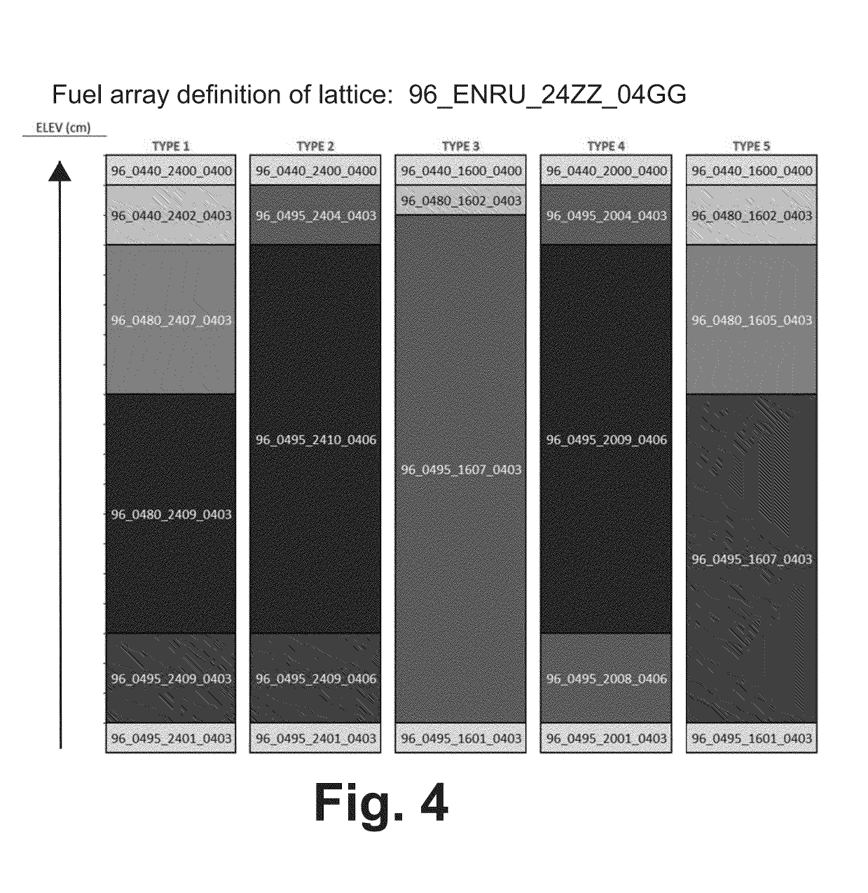

With reference to FIG. 4, the illustrative reactor core includes fuel assemblies of five different axial zone types. FIG. 4 diagrammatically shows the five fuel assembly types used in assembling the reactor core 2. In FIG. 4, the composition of each axial zone is specified by a code of the form: “96_ENRU_{—}24ZZ_{—}04GG”, where “ENRU” denotes the ²³⁵U enrichment (in xx.xx wt-%), 24ZZ denotes twenty-four Al₂O₃—B₄C burnable poison rods (BPR) with ZZ wt-% B₄C (varying with axial zone), and “04GG” denotes four UO₂Gd₂O₃ spike fuel rods with GG wt-% gadolinia (varying with axial zone). Thus, for example, the lowermost zone of the type 1 fuel assembly has code “96_{—}0495_{—}2401_{—}0403” indicating the fuel rods in this zone have ²³⁵U enrichment of 4.95 wt-%, the BPR's have 1 wt-% B₄C in this zone, and the UO₂Gd₂O₃ rods have 3 wt-% gadolinia in this zone. Fuel assembly types 1 and 2 have twenty-four BPR as shown in FIG. 3, while types 3 and 5 have sixteen BPR and type 4 has 20 BPR. In all cases the BPR are preferably distributed substantially uniformly over the fuel assembly lattice.

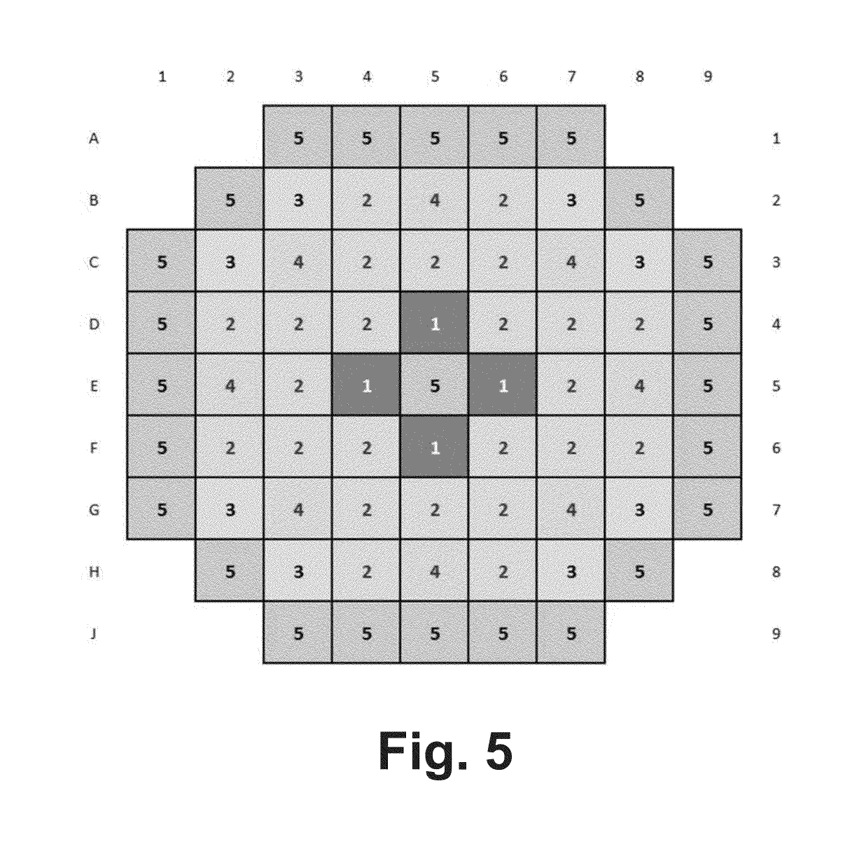

With reference to FIG. 5, the core loading assembly map for the nuclear reactor core 2 is shown for the illustrative example. The illustrative core 2 is constructed using sixty-nine fuel assemblies of types 1-5 as indicated in the map of FIG. 5. The average ²³⁵U enrichment over the core is 4.8626 wt-%. The sixty-nine fuel assemblies include four type 1 fuel assemblies, twenty-four type 2 fuel assemblies, eight type 3 fuel assemblies, eight type 4 fuel assemblies, and twenty-five type 5 fuel assemblies, having the layout shown in FIG. 5.

The disclosed cycle management approach uses control rod exchanges (i.e., adjustments) for cycle management. In the illustrative example, spike fuel with Gd (UO₂—Gd₂O₃) is used for reactivity control, along with axially zoned Al₂O₃—B₄C burnable poison rods. The cycle management design example employs a full power cycle length greater than 46 months without refueling, and does not use soluble boron in the primary coolant to control reactivity. Fuel enrichment for the illustrative example is less than 5% ²³⁵U. No fuel assembly shuffling is employed in the illustrative example.

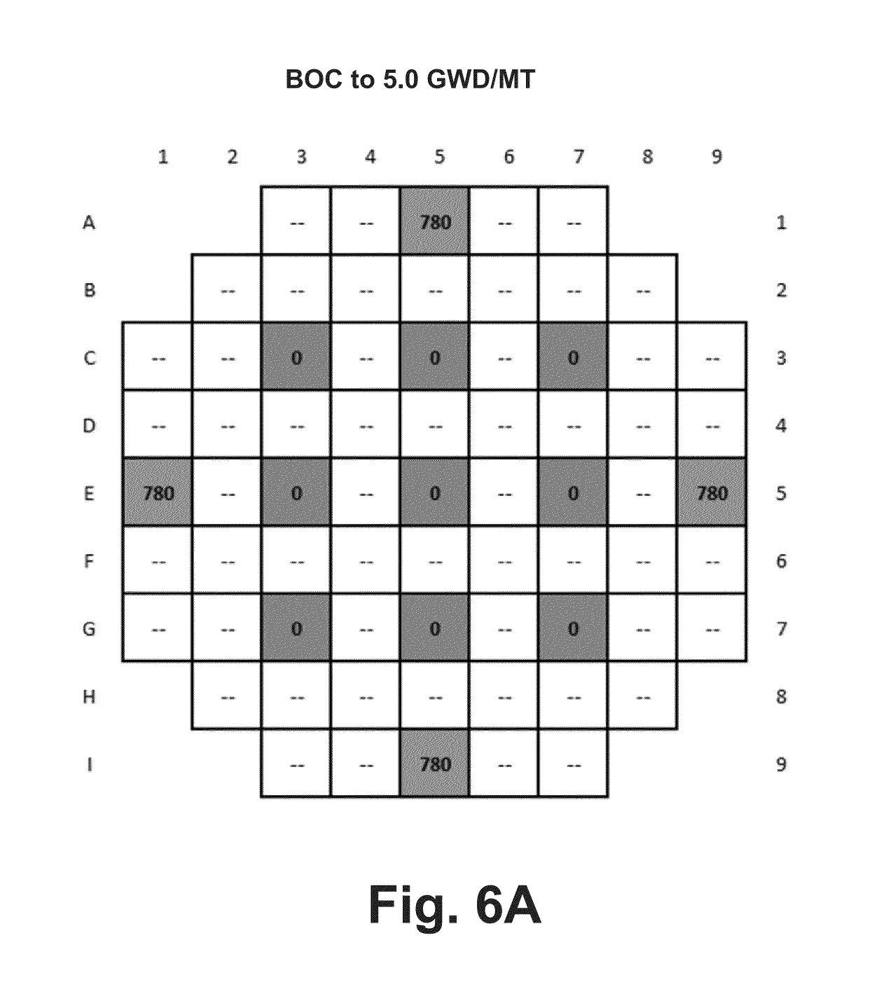

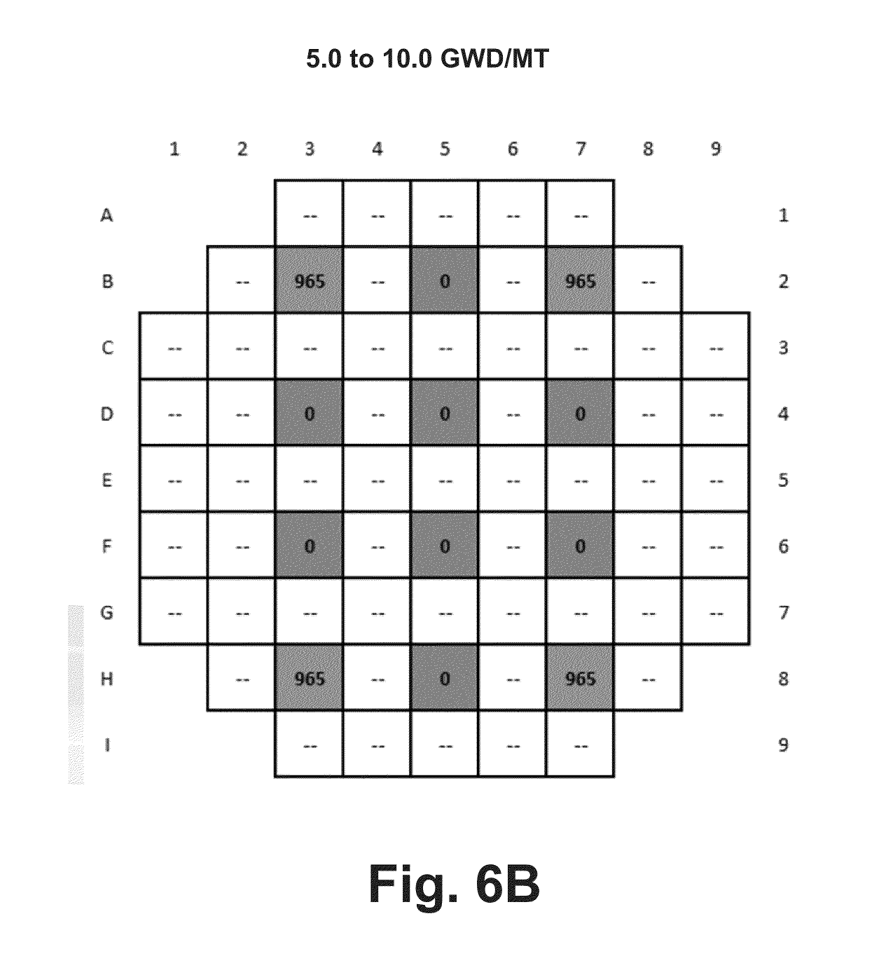

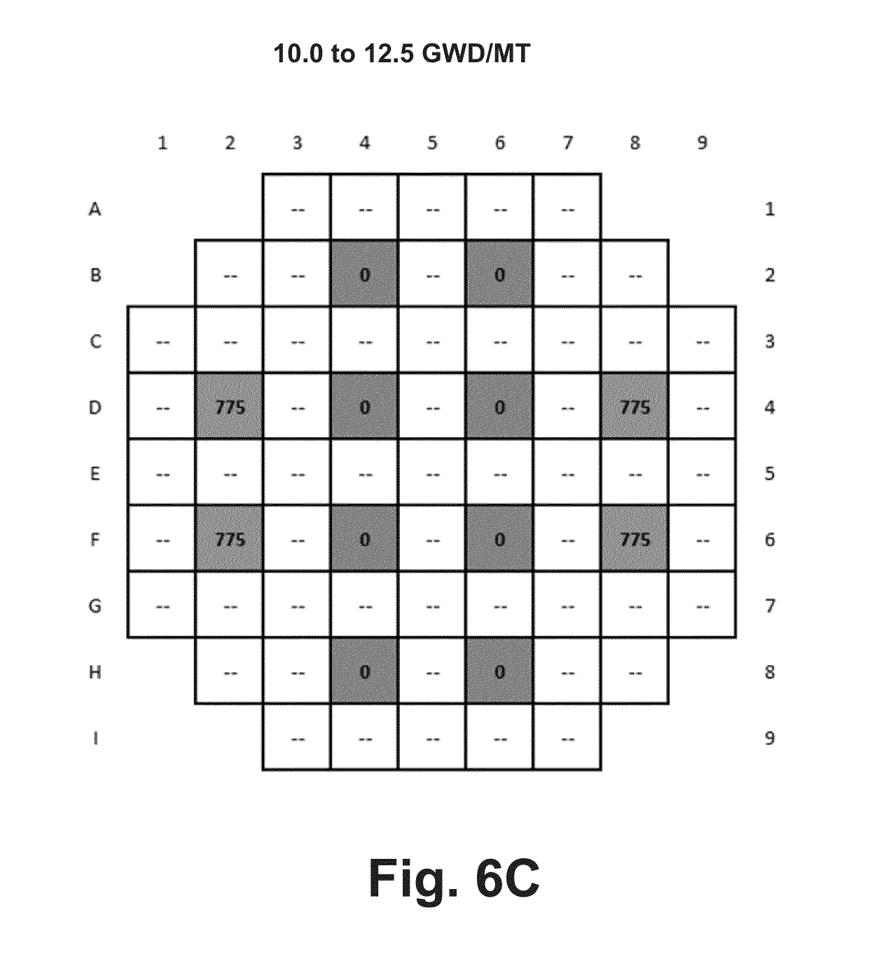

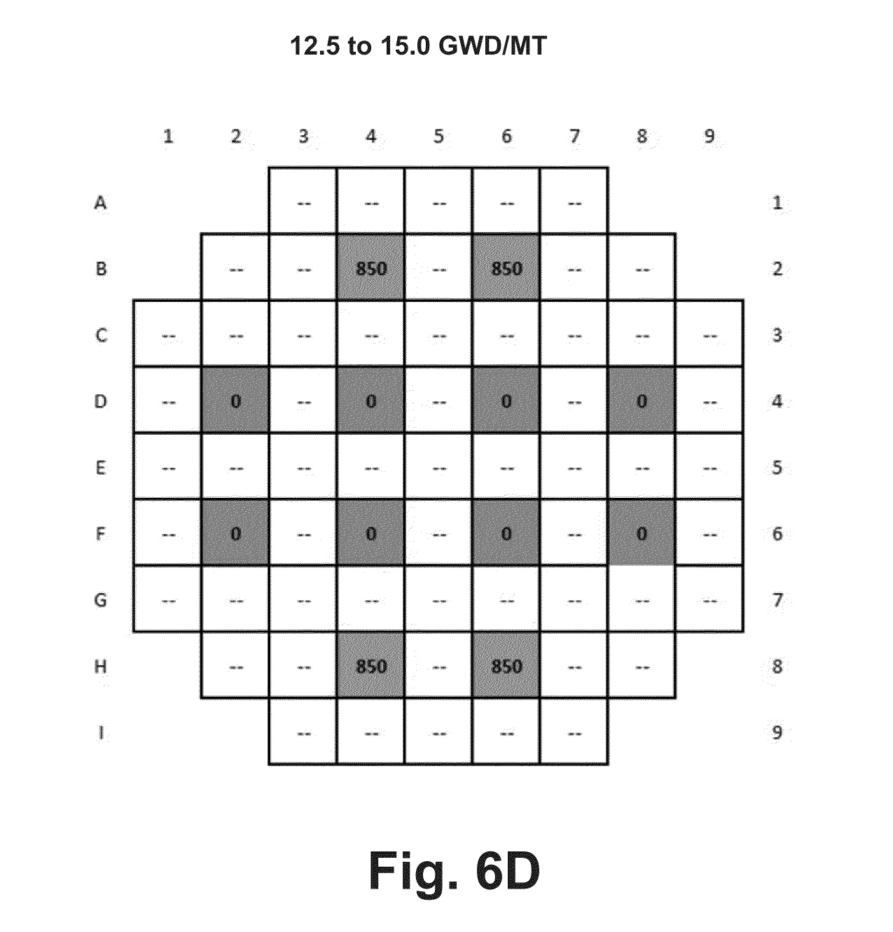

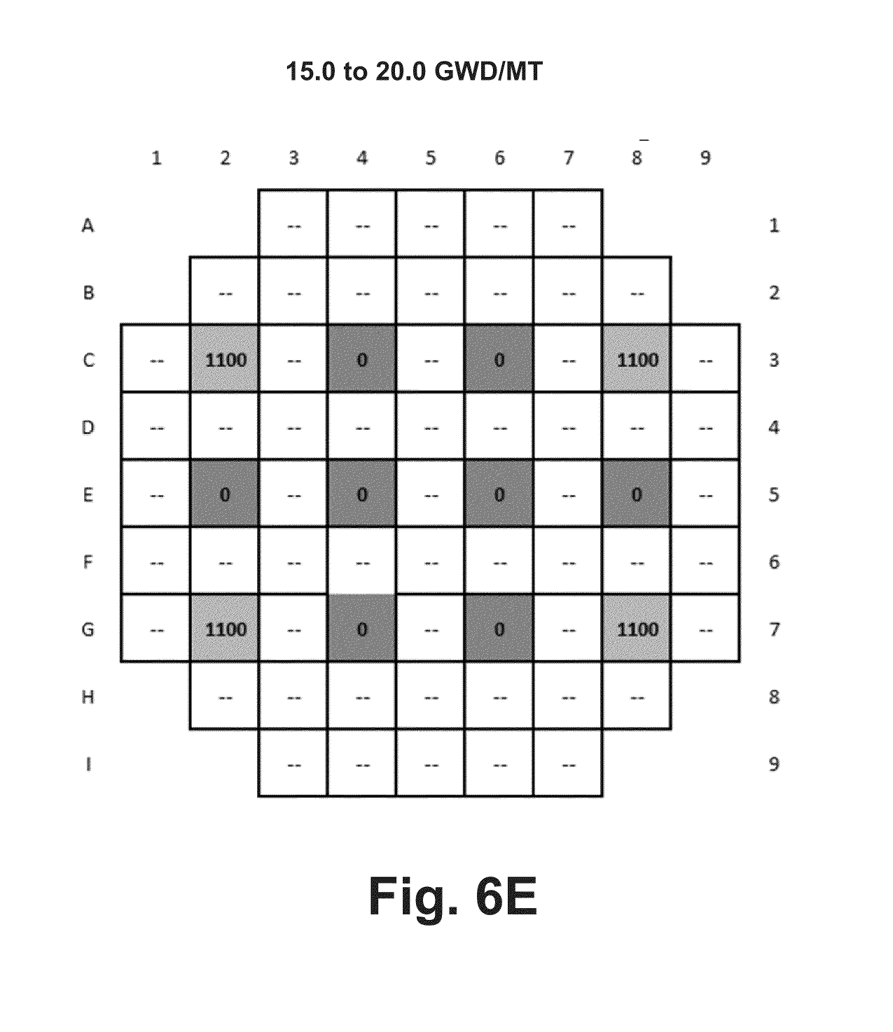

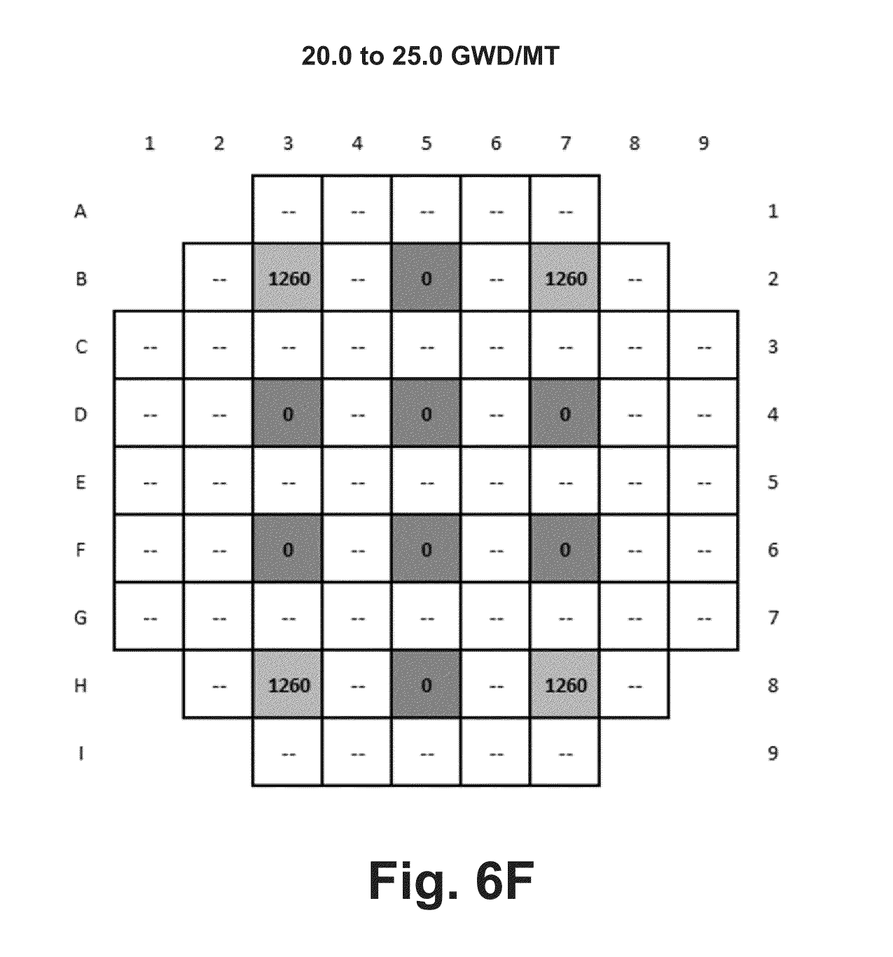

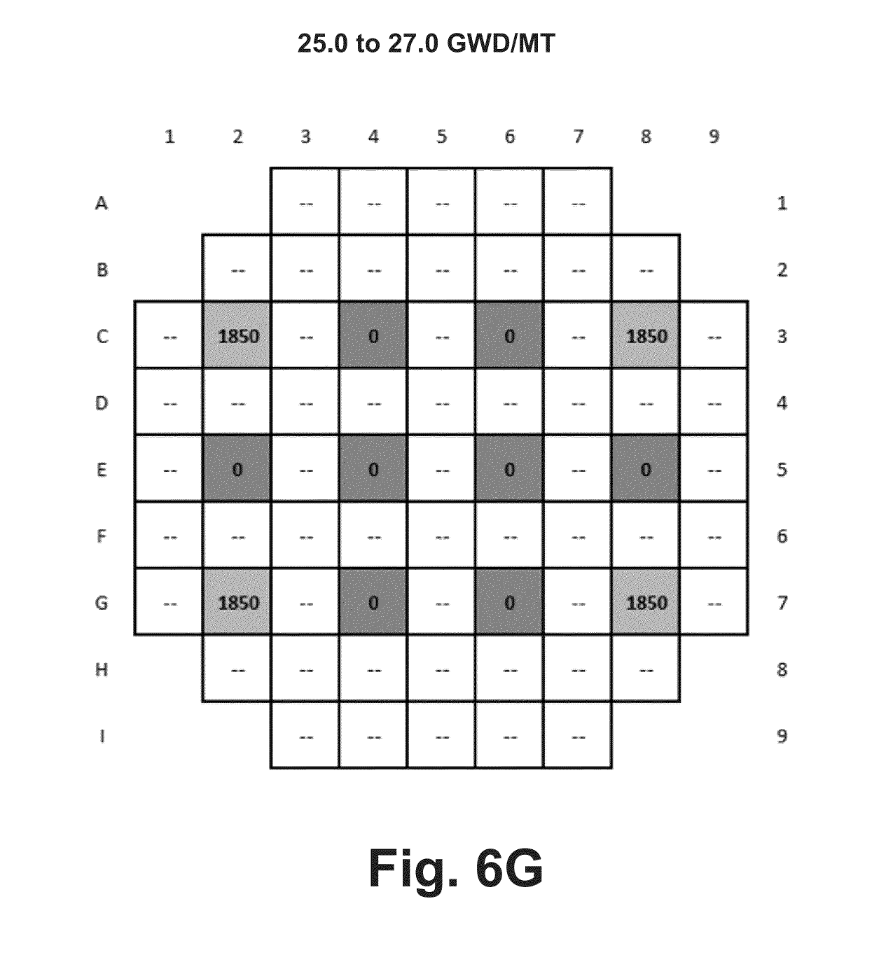

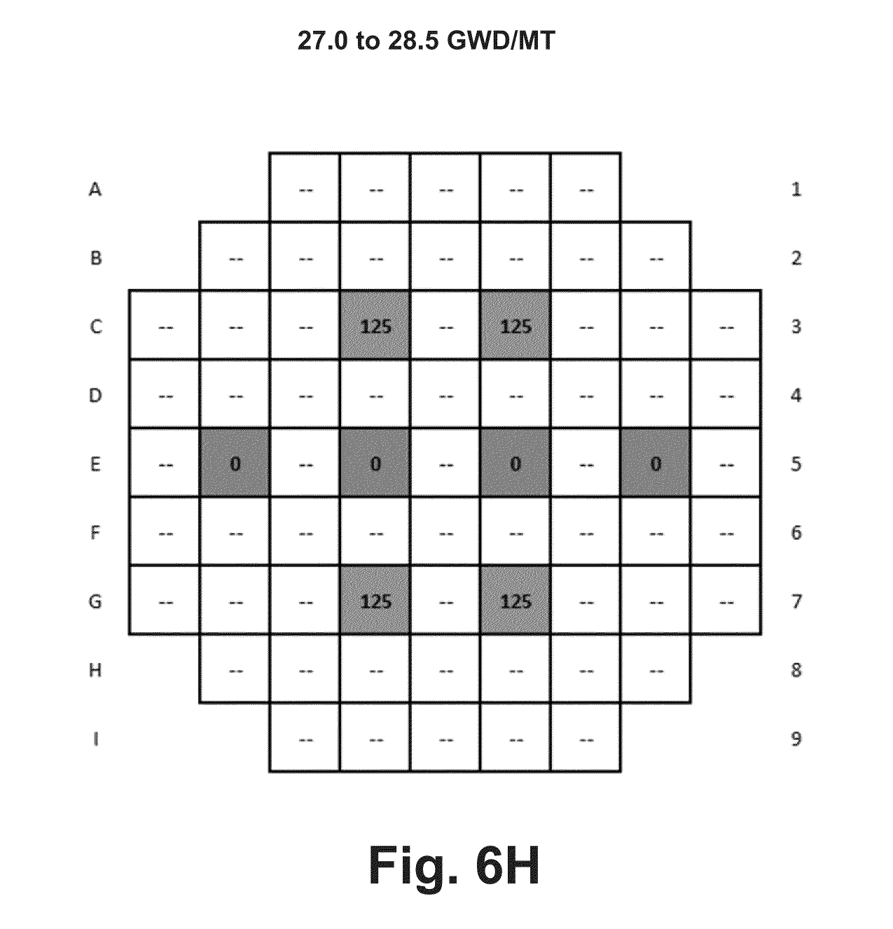

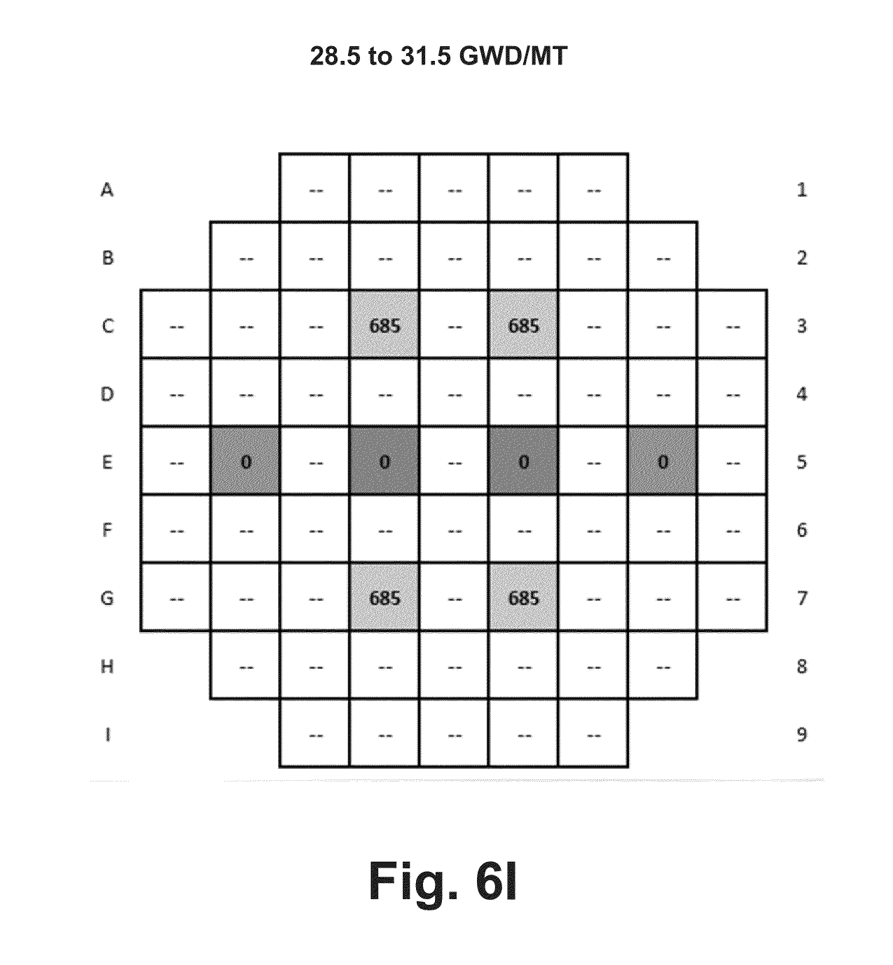

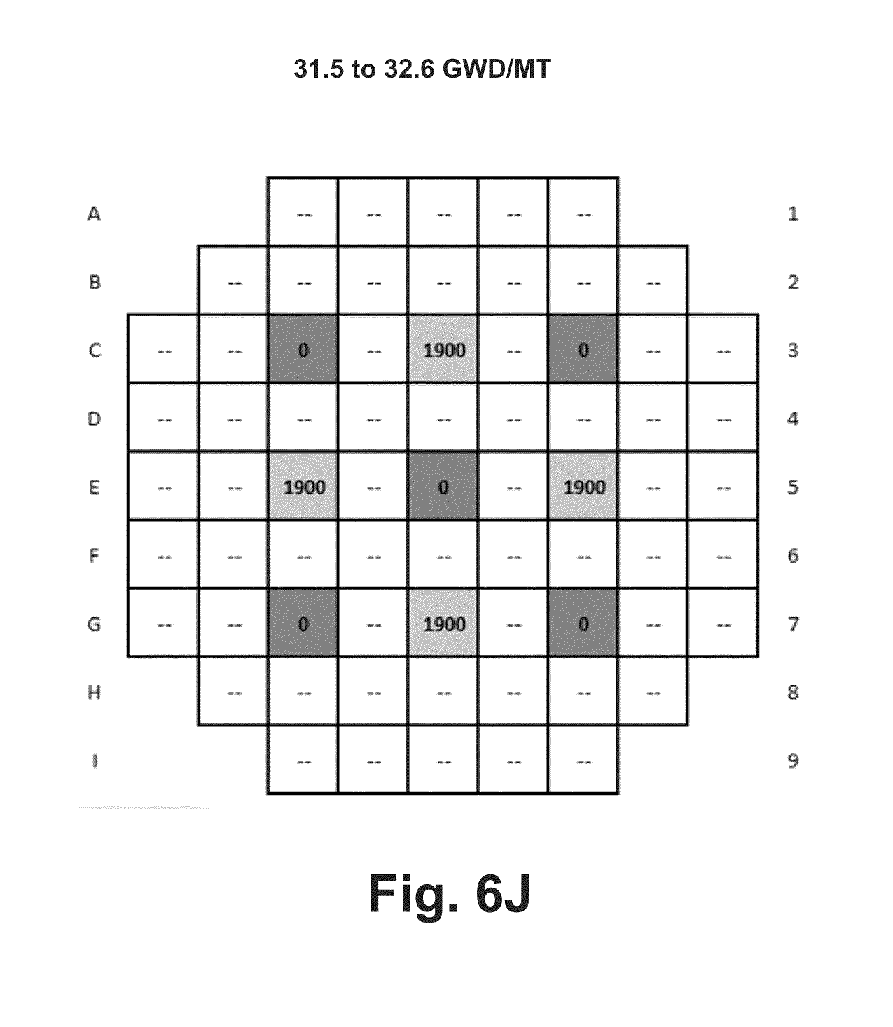

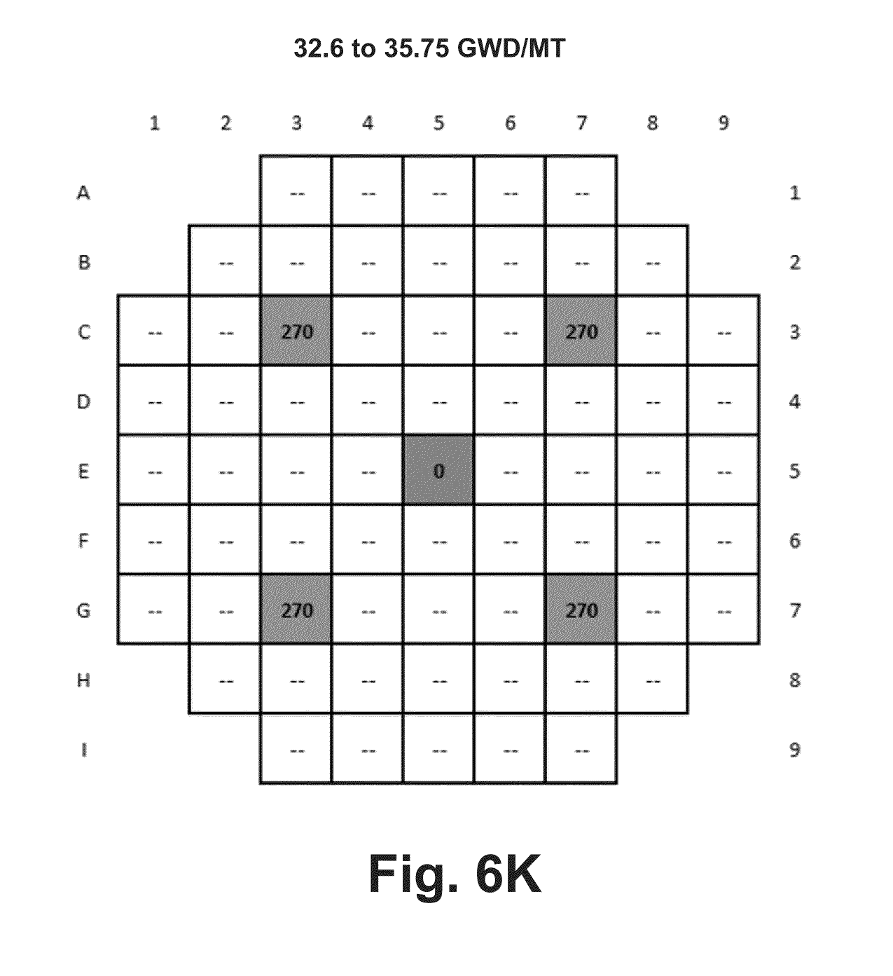

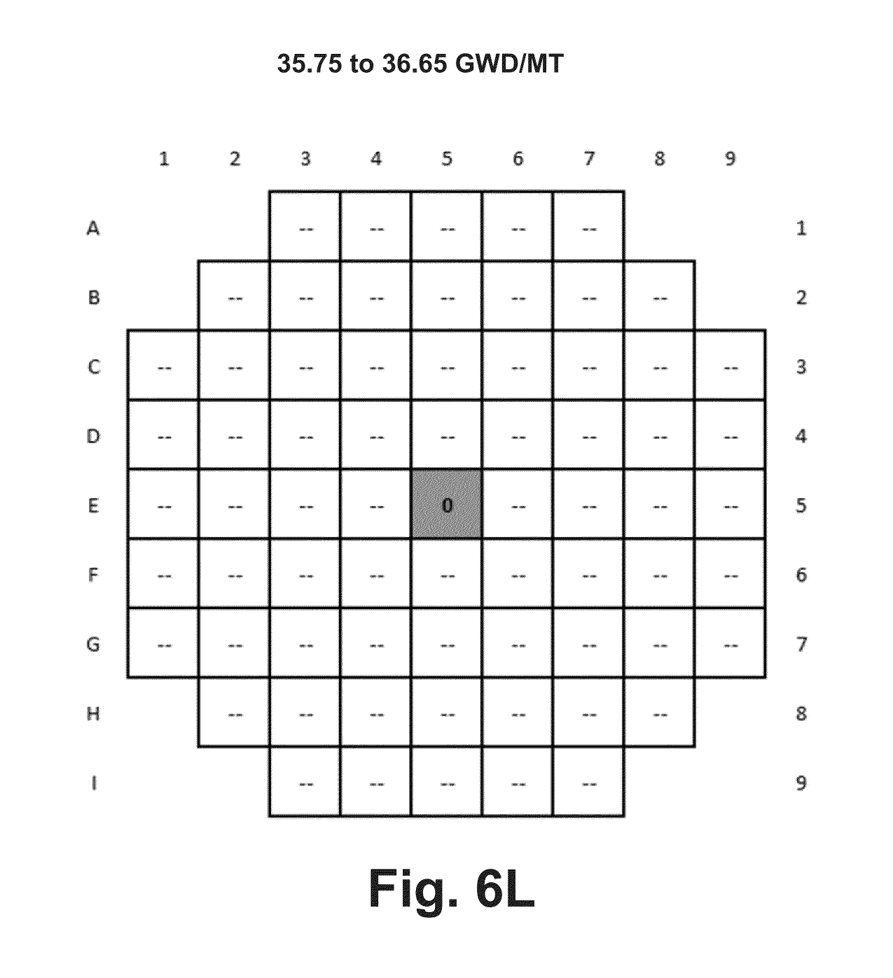

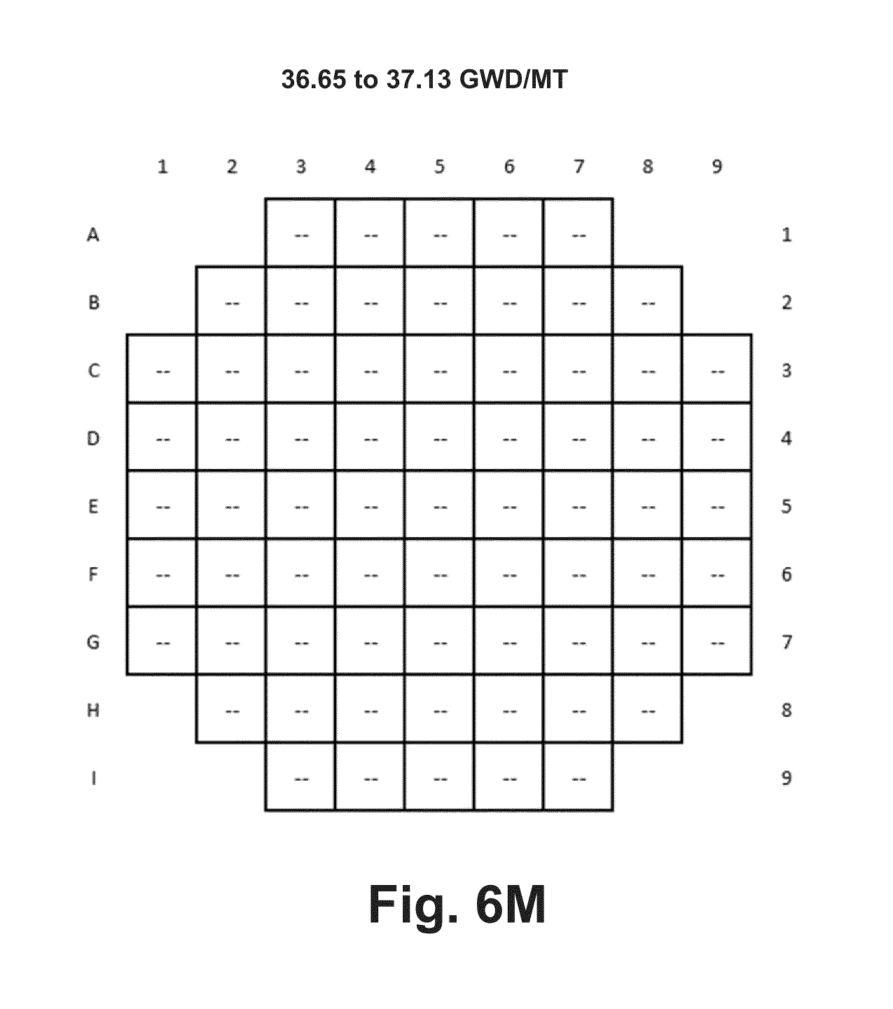

With reference to FIGS. 6A-6M, the disclosed cycle management employs twelve CRA patterns spanning intervals of burn-up from beginning of cycle (BOC) to end of cycle (EOC). The header of each of FIGS. 6A-6M indicates the burn-up range in GWD/MT (gigawatt days/metric ton) over which the illustrated CRA pattern is maintained. In the illustrative example an “all rods out” (ARO) condition is expected to be obtained at 36.65-36.7 GWD/MT (see FIG. 6M). Control sequences are maintained for up to 5 GWD/MT. One bank of CRA within each control rod pattern is allowed to “float” to maintain power level and to control excess reactivity. (In other words, the floating CRA are adjustable to maintain or adjust reactor power level). In FIGS. 6A-6M, the fuel assemblies with floating CRA are denoted by crosshatching. FIGS. 6A-6M show the rod configurations for various time intervals (as measured by burn-up 54) from BOC through the fuel cycle. In FIGS. 6A-6M the notation “--” indicates an ARO (all rods out) condition, while a numerical value indicates CRA withdrawal in millimeters. For example, in FIG. 6A the fuel assemblies labeled “--” have their CRA fully withdrawn (ARO), the fuel assemblies labeled “0” have their CRA fully inserted, and the fuel assemblies labeled “780” have their CRA withdrawn 780 mm. However, the four fuel assemblies labeled “780” are the floating fuel assemblies, and so the 780 mm withdrawal is adjustable to maintain or adjust the reactor power level.

With brief reference back to FIG. 1, to implement the reactivity control of FIGS. 6A-6M the CRA pattern schedule 52 stores the CRA patterns shown in FIGS. 6A-6M in a suitable format, for example listing the CRA position in millimeters of withdrawal for each fuel assembly and further identifying the fuel assemblies having floating CRA, with each CRA pattern indexed by its burn-up interval. To perform the reactivity control, the CRDM controller 50 monitors the burn-up 54 and switches from one CRA pattern to the next CRA pattern as the burn-up progresses from one burn-up interval to the next. Additionally, a monitoring system (not shown) monitors reactor power level and, if needed, the CRDM controller 50 adjusts the CRA positions of the floating fuel assemblies without adjusting the CRA positions of any of the other fuel assemblies in order to maintain the desired power level. Said another way, the CRA pattern defines the baseline power level, and feedback control of the floating CRAB provides real-time feedback control of the reactor power output.

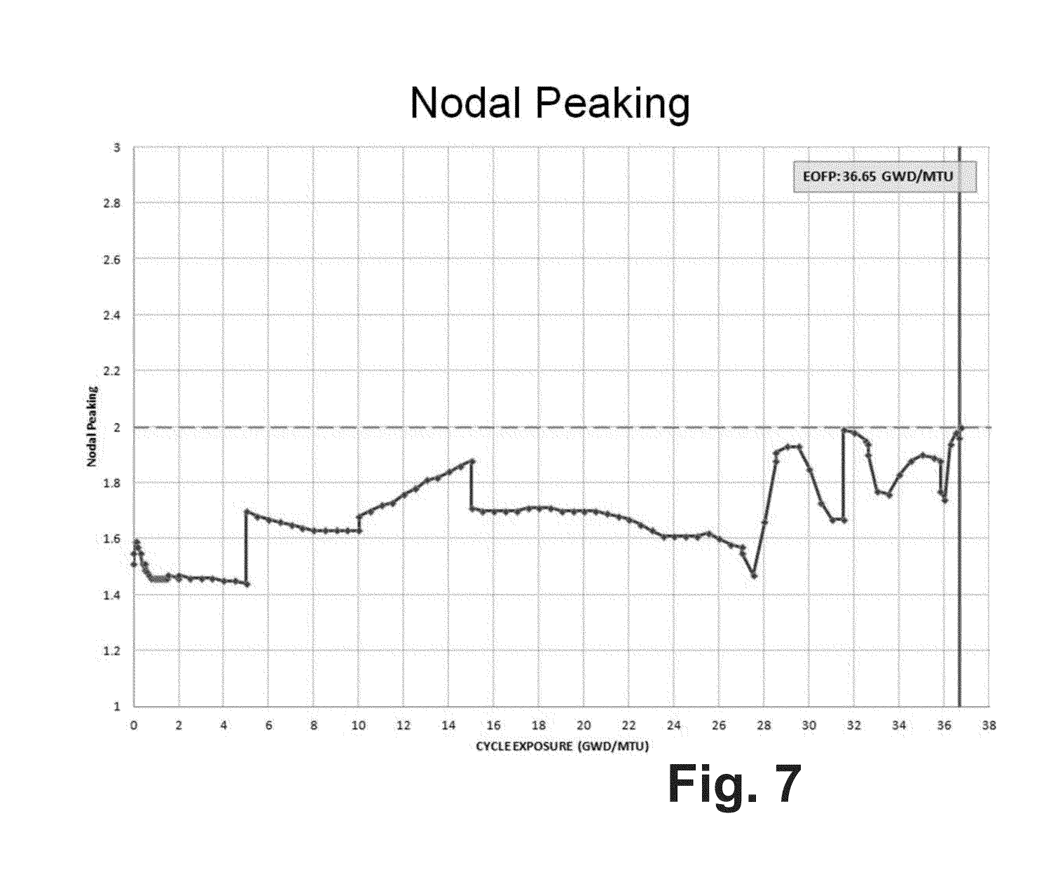

The above-described reactivity control has been simulated, and the results illustrated in FIGS. 6 and 7.

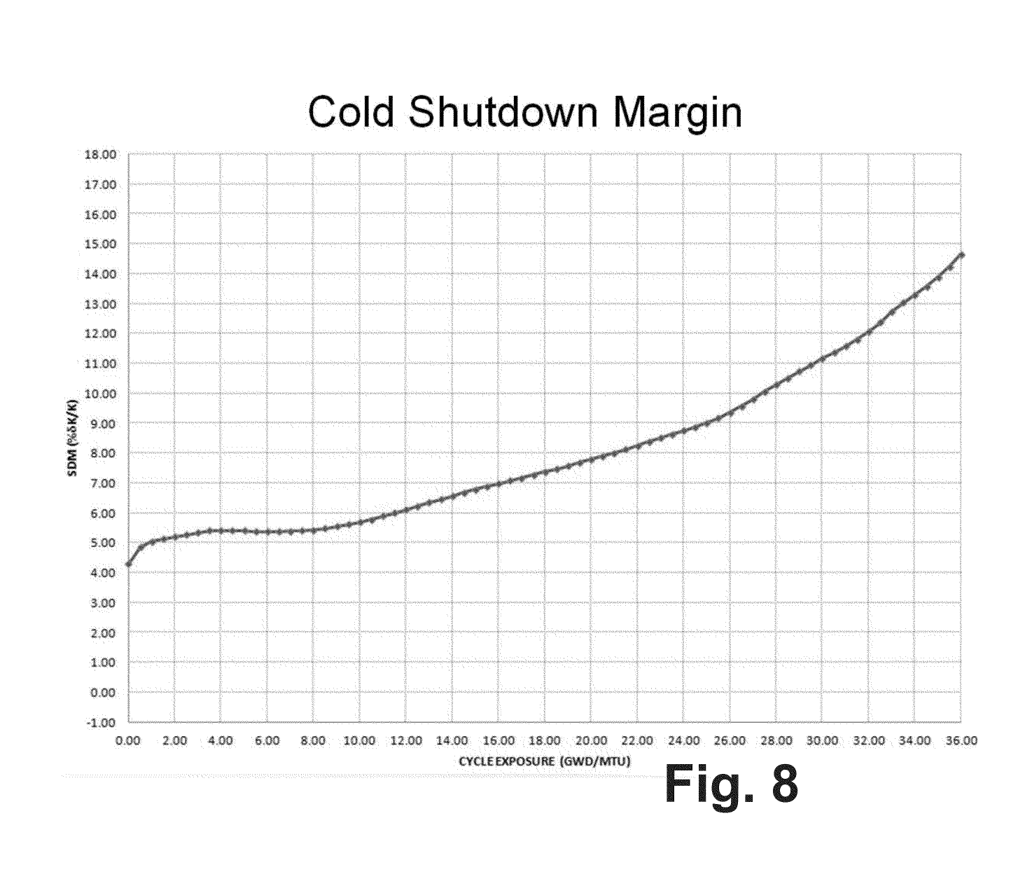

FIG. 7 shows the nodal peaking calculated for a simulation of the fuel cycle of the example set forth in FIGS. 3-5 including the control rod exchanges indicated by FIGS. 6A-6M. FIG. 8 shows the cold shutdown margin calculated for the same simulation.

The example of FIGS. 3-5 and 6A-6M is merely illustrative. More generally, it is disclosed herein that a PWR can be controlled by adjusting the CRA pattern as a function of burn-up. In this process, real-time power level control or adjustment is performed by feedback control of a small number of floating CRAB. In the illustrative example, between one and four floating CRAB are employed for feedback control in each burn-up interval, while the remaining 65-68 CRAB are held in a fixed position. As can be seen in FIGS. 6A-6M, the selection of floating CRAB varies between CRA patterns. This combination of a limited number of floating CRAB whose designation changes from pattern to pattern substantially reduces operational wear on any given CRDM, as each CRDM is operated in feedback control mode for only a small portion of the fuel life.

Moreover, as seen in the simulations of FIGS. 7 and 8, the disclosed PWR reactivity control provides good performance (small nodal peaking and large cold shutdown margin) over the entire fuel life without employing fuel assembly shuffling and without relying upon chemical shimming of the primary coolant using soluble boron or another chemical shim.

The precise allocation of CRA patterns over the burn-up from BOC to EOC can be determined by reactor simulations. In general, as burn-up increases the “average” withdrawal of rods increases to compensate for the burn-up, with an ARO condition for most or all fuel assemblies expected at EOC. Design of the CRA patterns can also be assisted by design of the “baseline” reactivity defined by the distribution of enrichment and poison in the reactor core. This was described for the illustrative example with reference to FIGS. 3-5.

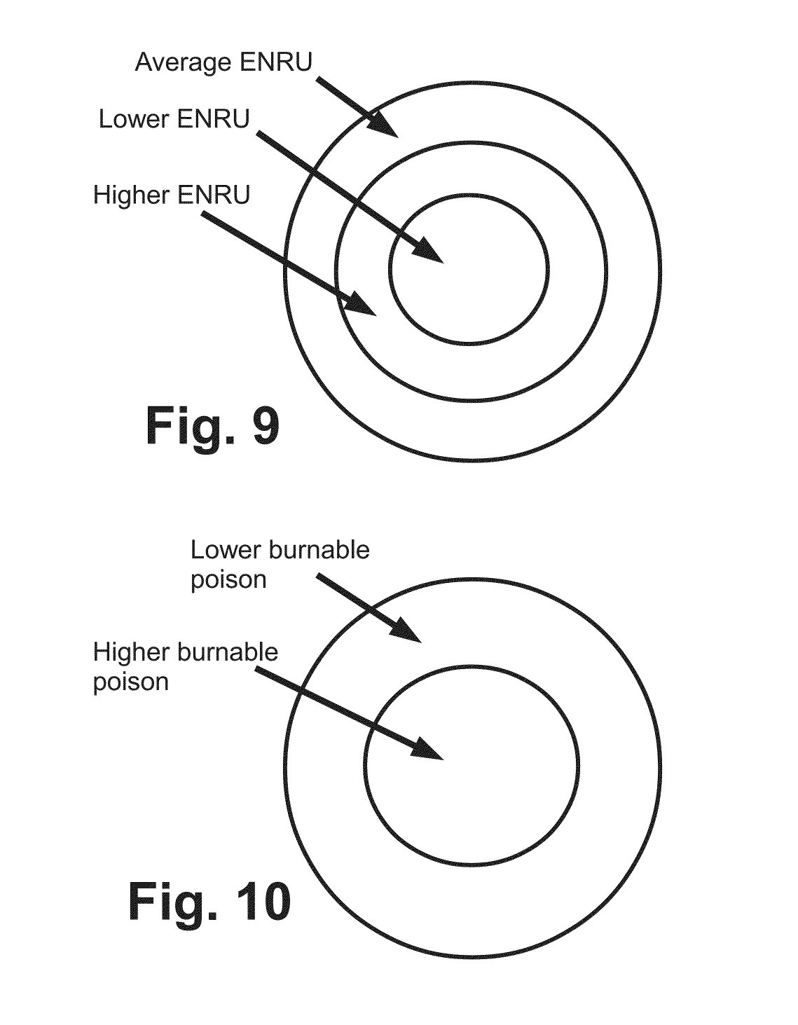

With reference to FIGS. 9 and 10, general guidelines for selecting the lateral enrichment and poison distributions to obtain the baseline reactivity are shown. In the case of enrichment, the central region of the reactor core (which is diagrammatically shown as having a circular lateral profile in FIG. 1, but which in general may have the shape of the core shown in FIG. 5, a square shape, or some other lateral profile) should have the lowest (i.e., below average) enrichment. The outer portion of the reactor core should have enrichment close to the average enrichment intended for the core, while an intermediate region of the core should have the highest (i.e., above average) enrichment. The lower central region enrichment compensates for the typically higher neutron density at core center. A low enrichment at the outer portion of the core can be problematic as it can result in undesirably low burn-up at the outer portion where the neutron density is lowest. (This can be compensated by fuel assembly shuffling, but avoiding fuel assembly shuffling is advantageous and is a goal of the disclosed reactivity control). FIG. 10 diagrammatically shows the lateral burnable poison distribution, which is higher near core center and lower at the core periphery. The higher burnable poison at center suppresses reactivity in the central core region during the initial portion of the fuel life, but this suppression decreases as burn-up progresses as the burnable poison is depleted along with the fuel. A lower peripheral burnable poison concentration avoids excessive reactivity suppression at the periphery during the initial portion of fuel life.

Axial zoning of the enrichment and poison concentration also assists in enabling full reactivity control by adjustment of CRA patterns over the burn-up cycle. FIG. 4 shows the axial zoning for the illustrative example. In general, the axial zoning compensates for the axially disjoint effect of the control rods 42 being partially inserted into the fuel assembly 20 (i.e., the partially inserted control rods absorb neutrons to suppress reactivity in the upper core portion into which the control rods are inserted, but do not absorb neutrons in the lower core portion to which the partially inserted control rods do not extend).

The foregoing guidelines are merely a starting point, and the designed CRA patterns and enrichment and poison distributions may deviate significantly from these guidelines. Design by simulations is feasible because the total number of CRA patterns (which can be thought of as burn-up cycle zones) and the total number of axial zones is limited. For example, in the illustrative example the burn-up cycle is partitioned into twelve burn-up zones and the axial zoning employs three to five axial zones for each fuel assembly type.

The disclosed cycle management approach using control rod exchanges enables extended cycle length (reduced number of outages across plant life) and advantageously does not employ soluble boron for reactivity control. Fuel assembly shuffling can also be eliminated. The control rod exchanges can be performed by the CRDM's and does not require shutdown and opening of the pressure vessel. Using the disclosed cycle management approach without shimming the PWR using a soluble neutron poison and without performing fuel assembly shuffling, it is expected that the reactor can provide constant burn rate over a burn-up cycle longer than 2 years, and typically at least 2.5 years. The illustrative embodiment is estimated to provide constant burn rate over a burn-up cycle of at least 4 years without shimming the PWR using a soluble neutron poison and without performing fuel assembly shuffling.

It is alternatively contemplated to employ the disclosed cycle management approach using control rod exchanges in conjunction with the use of a soluble poison such as soluble boron.

It is alternatively contemplated to employ the disclosed cycle management approach using control rod exchanges in conjunction with fuel assembly shuffling. In this case the disclosed cycle management can be employed as disclosed for each interval between a shuffling event, to optimize reactivity during each such interval.

It is alternatively contemplated to employ the disclosed cycle management approach using control rod exchanges in conjunction with both the use of a soluble poison such as soluble boron and with fuel assembly shuffling.

The illustrative example employs one control rod assembly (CRA) 40 operated by one CRDM 8 for each fuel assembly 20. Said another way, there is a one-to-one correspondence between CRA's and fuel assemblies. While this arrangement has advantages such as facilitating alignment between the CRA and the fuel assembly, the disclosed reactivity management processes are suitably employed in reactors that do not have this one-to-one correspondence. For example, each CRA may insert into two or more adjacent fuel assemblies, or in another alternative two or more CRA's may insert into a single fuel assembly. As yet another variant, some fuel assemblies might not have any CRA at all.

The illustrative embodiment employs only gray rods, that is, each CRA is adjustable continuously (or with fine gradations) between the fully inserted and fully withdrawn positions. Another known type of control rod is the shutdown rod, in which the CRA is either fully withdrawn or fully inserted. It is contemplated to practice the disclosed reactivity control in conjunction with a reactor that includes some shutdown rods. In the illustrative example, a shutdown rod (or, more precisely, shutdown CRA) can be used in conjunction with any fuel assembly which is either fully inserted or fully withdrawn for all CRA patterns (i.e., for all FIGS. 6A-6M).

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. A fuel cycle management method performed in conjunction with a pressurized water reactor (PWR) including a nuclear reactor core comprising an array of fuel assemblies each fuel assembly having an associated control rod assembly (CRA), the method comprising:
dividing the fuel cycle into burn-up intervals; and
for each burn-up interval, controlling power by adjusting the CRA's of a selected sub-set of fuel assemblies while keeping the CRA's of other fuel assemblies fixed.

2. The method of claim 1 wherein no soluble poison is used for the fuel cycle management.

3. The method of claim 1, wherein no fuel assembly shuffling is used for the fuel cycle management.

4. The method of claim 1, wherein a plurality of CRA patterns are defined each CRA pattern defining a set of fixed positions for the CRA's except for a sub-set of one or more CRA's designated as floating CRA's, each burn-up cycle employs a selected one CRA pattern, and in each burn-up cycle the controlling comprises adjusting only the designated floating CRA's to control power level of the nuclear reactor.

5. The method of claim 4, wherein the fuel assemblies have axially varying ²³⁵U enrichment.

6. The method of claim 5, wherein the fuel assemblies include burnable poison rods with axially varying burnable poison concentration.

7. The method of claim 4, wherein the fuel assemblies include burnable poison rods with axially varying burnable poison concentration.

8. A method comprising:
operating a pressurized water reactor (PWR) comprising a nuclear reactor core disposed in a pressure vessel over a burn-up cycle that is divided into a plurality of burn-up intervals, the operating including:
for each burn-up cycle, positioning a set of control rod assemblies (CRA's) used for controlling reactivity of the nuclear reactor core in accordance with a CRA pattern designated for the burn-up cycle; and
controlling power level of the PWR by adjusting a sub-set of the CRA's designated as floating CRA's while not adjusting the CRA's that are not designated as floating CRA's.

9. The method of claim 8 wherein the operating does not include shimming the PWR using a soluble neutron poison.

10. The method of claim 8 wherein the operating does not include performing fuel assembly shuffling.

11. The method of claim 8 wherein the operating does not include shimming the PWR using a soluble neutron poison and does not include performing fuel assembly shuffling.

12. The method of claim 11 wherein the burn-up cycle is greater than two years and the operating provides constant burn rate over the burn-up cycle.

13. The method of claim 11 wherein the burn-up cycle is at least 2.5 years and the operating provides constant burn rate over the burn-up cycle.

14. The method of claim 11 wherein the burn-up cycle is at least 4 years and the operating provides constant burn rate over the burn-up cycle.

15. The method of claim 8 wherein the CRA patterns in conjunction with axial variation in the nuclear reactor core of at least one of ²³⁵U enrichment and burnable poison concentration provide constant burn rate over the burn-up cycle.

16. The method of claim 11 wherein the axial variation in the nuclear reactor core of at least one of ²³⁵U enrichment and burnable poison concentration comprises axial zone variation in which the ²³⁵U enrichment and burnable poison concentration are constant within finite axial zones and change abruptly between axial zones.

17. An apparatus comprising:
a pressurized water reactor (PWR) including a pressure vessel, a nuclear reactor core disposed in the pressure vessel and immersed in primary coolant water, control rod assemblies (CRA's) insertable into the nuclear reactor core to control reactivity, and control rod drive mechanisms (CRDM's) operating the CRA's, the nuclear reactor core having at least one of an axially varying ²³⁵U enrichment and an axially varying burnable poison concentration; and
a CRDM controller comprising an electronic data processing device communicating with the CRDM's to control the CRA's over a burn-up cycle that is divided into a plurality of burn-up intervals, the CRDM controller configured to, for each burn-up interval:
position the CRA's in accordance with a CRA pattern designated for the burn-up interval, the CRA pattern defining a set of fixed positions for the CRA's except for a sub-set of CRA's designated by the CRA pattern as floating CRA's, and
control power level of the PWR by adjusting the floating CRA's without not adjusting the CRA's that are not designated by the CRA pattern as floating CRA's.

18. The apparatus of claim 17, wherein the primary coolant water does not contain a soluble neutron poison.

19. The apparatus of claim 17, wherein the CRDM controller stores or has access to storage that stores a CRA pattern schedule defining the burn-up intervals of the burn-up cycle and the CRA patterns designated for the burn-up intervals.

20. A non-transitory storage medium storing instructions executable by an electronic data processing device communicating with control rod drive mechanisms (CRDM's) that move control rod assemblies (CRA's) into or out of the nuclear reactor core of a nuclear reactor, execution of the stored instructions by the electronic data processing device causing performance of a method including, for each burn-up interval of a plurality of burn-up intervals making up a burn-up cycle of the nuclear reactor core:
causing the CRDM's to position the CRA's in accordance with a CRA pattern designated for the burn-up cycle, the CRA pattern defining a set of fixed positions for the CRA's except for a sub-set of CRA's designated by the CRA pattern as floating CRA's, and
adjusting the floating CRA's without not adjusting the CRA's that are not designated by the CRA pattern as floating CRA's in order to control reactor power generated by the nuclear reactor.
